(19) United States
(12) Patent Application Publication
(10) Pub. No.: US 2014/0067344 A1
(43) Pub. Date: Mar. 6, 2014

(54) METHOD FOR DETERMINATION OF PERFORMANCE OF AN ACCUMULATOR-UNIT

(71) Applicant: Denso Corporation, Kariya-city (JP)

(72) Inventors: Toshiyuki KAWAI, Toyohashi-city (JP); Lawrence ALGER, Nottingham (GB)

(73) Assignee: Denso Corporation, Kariya-city (JP)

(21) Appl. No.: 14/010,936

(22) Filed: Aug. 27, 2013

(30) Foreign Application Priority Data
Aug. 29, 2012 (DE) 102012107995.1

(51) Int. Cl. H01M 10/48; G06F 17/50

(52) U.S. Cl. CPC H01M 10/482; G06F 17/5009
USPC 703/2; 429/91

(57) ABSTRACT

The disclosure relates to a method for determination of a maximum allowable load current of an energy storage cell by means of a substitute model. The Parameters of the substitute model are adapted during the lifetime of the energy storage cell. The substitute model contains two or more RC-elements. The respective parameters of a RC-element preferentially are adapted during separate time intervals. The disclosure further relates to a method for determination of a maximum performance of an accumulator-unit having two or more energy storage cells. The performance is preferentially calculated from a maximum allowable load current of the weakest energy storage cell and the sum of the respective voltages being produced at the energy storage cells at appliance of this maximum current. The disclosure also relates to a control unit for performing the method.

### CROSS REFERENCE TO RELATED APPLICATION

This application is based on German Patent Application No. 102012107995.1 filed on Aug. 29, 2012, the disclosure of which is incorporated herein by reference.

### TECHNICAL FIELD

The present disclosure relates to a method for determination of a maximum allowable load current of an energy storage cell during its lifetime as well as an application of the method in a method for determination of the performance of an accumulator-unit of a vehicle. The present disclosure further relates to a control unit for determination of the performance of an accumulator-unit of a vehicle.

### BACKGROUND

Accumulator-units usually contain two or more energy storage cells that are connected in series. It is known in practice to simulate the performance of an accumulator-unit and/or the energy storage cells contained in it during their lifetime. Until now, there are mainly used purely time-depending models that e.g. calculate the maximum performance by a linear or parabolic function depending on the operation time of the accumulator-unit. Thereby, the performance is indicated between a maximum value at the beginning of the lifetime and a pre-defined minimum value at the end of the lifetime.

### SUMMARY

The known models for determination of the performance are not designed optimally. On the one hand, when the actual performance is higher than the performance calculated according to the model, they do not allow for exploiting the whole power of the accumulator-unit. On the other hand, if the actual performance is lower than the calculated performance, damages to the accumulator-unit are possible. In particular, a deterioration chain-effect can occur. Such an effect is due to the fact, that a damaged energy storage cell can only sustain a reduced maximum load current. Thus, when the cell actually has a lower performance than it was calculated according to the model, it may often occur the case that the cell is overloaded and damaged further. The additional damage will deteriorate the performance and thus increase the risk for additional overloading of the cell and new damages. This chain-effect cannot be detected by the prior known models. Accordingly the prior known models have to be dimensioned very conservatively in order to avoid damages.

It is an objective of the present disclosure to provide a method for determination of a maximum allowable load current of an energy storage cell during its lifetime as well as a method for determination of a performance of an accumulator-unit, by which the respective actual performance can be determined as precisely as possible.

It is further an objective of the present disclosure to provide a control unit, by which such determination may be performed at an accumulator-unit of a vehicle.

The disclosure solves these objectives with the features in the respective independent claims.

According to the disclosure, there is provided a method for determination of a maximum allowable load current of an energy storage cell during its lifetime, wherein a substitute model is used for simulation of the charging and/or discharging behavior of the energy storage cell. The substitute model contains a series connection of a series resistor and at least two RC-elements. A RC-element consists of a parallel connection of each a resistor and a capacitor. The parameters of the substitute model, namely the resistance of the series resistor, the resistances of the resistors and the capacities of the capacitors in the RC-elements are adapted during the lifetime of the energy storage cell.

A substitute model designed in this way may be used to calculate the run of voltage at an energy storage cell that will emerge for any arbitrary run of the load current at the energy storage cell. In particular, by using the substitute model also a run of voltage can be determined within ranges of the load current, where the energy storage cell would actually be damaged. Thus, in the model all theoretically possible load ranges can be represented. Consequently, anticipation calculations can be performed to avoid such runs of current and/or such voltages at the energy storage cell that would lead to damaging by suitable interventions at the electric consumers, i.e. external electric devices, or at any other suitable place in the circuit.

By comparison of the calculated run of voltage at the substitute model with a measured run of voltage at the energy storage cell it can be determined, if deterioration of the performance has occurred. Comparison of runs of voltages means that at least some measured data points may be compared to corresponding values calculated from parameters of the simulation model. Thus, comparison of runs of voltages e.g. means that a best fit curve may be calculated by using parameters of the simulation model, in particular the parameters of an RC-element to be adapted, and by comparison with measured values of the overall voltage of an energy storage cell. A run of voltage is defined as set of values from the same voltage within a specific time period. A run of voltage may cover a long time period and contain a huge number of single values. It may also cover only a short time period and contain only two or few values. A run of voltage may be present in digital or analogue form. In the following the formulation “run of voltage” will be used as it is easy to understand with reference to the attached drawings. Deterioration may in particular be determined, when the measured run of voltage (one or more values) at the energy storage cell is higher than the calculated run of voltage (one or more values of) at the substitute model. In such a case, the parameters of the substitute model may be adapted. Adapting process may preferentially be performed corresponding to the current-voltage-behavior being present after the deterioration. From the substitute model with the adapted parameters it may then be calculated, at which maximum allowable load current the energy storage cell may be operated in the future, without a further damaging of the energy storage cell occurring. Thus, the substitute model may very quickly be adapted to any occurring deterioration of the energy storage cell, with the result, that a deterioration chain-effect is avoided.

By the utilization of at least two RC-elements in the substitute model, several phenomena that are present during charging or discharging of the energy storage cell and that have a different dynamic behavior can be simulated at the substitute model. The energy storage cell may preferentially be an accumulator-cell like e.g. a lithium-ions-cell, a Ni—Cd-cell or any other energy storage cell, wherein the electric energy is stored in an electrolyte.

A first RC-element may e.g. serve for simulation of the dynamic behavior of the phenomenon that ions are leaving the minus terminal of the energy storage cell. A second RC-element may serve for simulation of the dynamic behavior of the phenomenon that ions are moving from the minus-terminal to the plus-terminal and a third RC-element may serve for simulation of the dynamic behavior of the phenomenon that ions are absorbed at the plus-terminal. Beyond that, further RC-elements may be provided that may simulate other phenomena, e.g. a dynamic behavior of an electrolyte during a state with long lasting permanent load of an energy storage cell. The number of RC-elements and their parameters may be adjusted to the respective type (chemic) and the intended capacitance of the energy storage cell. In particular, the parameters at the beginning of the lifetime may be determined by laboratory experiment, e.g. at the manufacturer. Such a determination may e.g. be performed by impedance-testing, in particular by electro-chemical impedance spectroscopy (EIS).

Adapting process of the parameters of the substitute model during the lifetime is preferentially performed by comparison of a measured run of the overall voltage at the energy storage cell that emerges due to a measured run of current at the energy storage cell with a calculated run of the overall voltage at the substitute model that is calculated based on the same measured run of current at the energy storage cell. An adapting cycle is preferentially started, when the measured run of current has a sharp rise to a stable current level, the stable current level lasting during a constant-current-interval, thus for a longer period. A constant current level is defined as a run of current with an essentially constant value of the measured current at the energy storage cell. Such a run of current with a sharp rise and a succeeding stable current level will be designated in the following as a step current.

The parameters of the substitute model are preferentially adapted such, that after a step current a calculated run of the overall voltage at the substitute model is approximated to the measured run of the voltage at the energy storage cell. By this adapting process of the substitute model after a step current a particularly precise adapting can be performed. When a step current occurs, a characteristic run of the overall voltage is produced at the energy storage cell. The run of the overall voltage is thereby composed of a basic voltage drop for the constant internal resistance of the energy storage cell and each a voltage drop that can be assigned to one of the previously mentioned phenomena. Likewise, the run of the calculated voltage is composed of a voltage drop at the series resistor and each of the RC-elements. By comparison of the calculated run of voltage with the measured run of voltage, the parameters can be each adapted in such a way, that the calculated run of voltage resulting from the adapted parameters will very accurately correspond to the measured run of voltage. Then, after adapting process, the substitute model is also suited for accurate calculation of the voltages for other runs of current.

Adapting process of the parameters of the substitute model is preferentially performed by non-linear regression calculations. The methods of non-linear regression calculations are known. They represent a possibility of adapting of the parameters, which is particularly fast and achievable with comparatively low calculation effort. Thus, for performing the method there can be used e.g. a control unit with a simple and inexpensive processor. Alternatively, adapting process of the parameters may be performed by arbitrary different methods, in particular by other regression calculation methods.

It is preferentially provided that adapting process of the parameters is performed separately for each RC-element during individual time intervals. Thus, the parameters for the first RC-element with the fastest dynamic behavior are preferentially adapted in a first time interval. Then, the parameters of a second RC-element with a slower dynamic behavior are adapted in a second time interval and the parameters for the further RC-elements with a more slowly reacting dynamic behavior are adapted in a third or further time interval. Due to the separation of the time intervals, a particularly precise adapting can be achieved. For example, during a first time interval for the determination of the resistance and the capacitance of the first RC-element a multitude of measurement points may be available. Thus, only two parameter changes are determined on the basis of a considerably higher number of measurement points in the first time interval, with a statistic error compensation being utilized. With other words, the ratio between the number of measurement points and the number of parameters to be adapted is advantageous. Preferentially, a difference between a measured run of voltage and a calculated run of voltage during a first time interval is exclusively used for adapting of a resistance and a capacitance of the first RC-element.

Preferentially, a difference between a measured run of voltage and a calculated run of voltage during a second or a further time interval is exclusively used for adapting of the respective resistance and the respective capacitance of the second or further RC-element. During the second or further time interval, again a multitude of measurement points may be available for calculating the respective two parameter variations. Thus, also here the advantages of statistic error compensation can be used.

Basically, the prior mentioned time intervals may be chosen arbitrarily. They are preferentially chosen such that a first time interval covers a duration of the fastest dynamic changes, thus a characteristic duration for the charging and/or discharging behavior of the first RC-element. A second time interval is preferentially chosen such that it does not immediately follow the first time interval but with an intermediate time duration. It preferentially covers a duration, during which a characteristic dynamic behavior of the next slower RC-element is present. A third time interval and further time intervals are preferentially chosen according to the same rule, such that these respectively follow a previous time interval with an intermediate time duration and each covers a characteristic period for the charging and/or discharging behavior of the respective RC-element.

In particular it is provided that adapting of the resistance and the capacitance of the first RC-element is performed, when the duration of the constant-current-interval is longer or equal to the characteristic time constant for the charging and/or discharging behavior of the first RC-element. Furthermore, the adapting may be performed during the first time interval mentioned above, wherein this first time interval begins at the occurrence of a step current in the measured run of current with succeeding constant current level. The duration of the first time interval may be chosen arbitrarily. It may especially cover a duration that is required to perform adapting process of the respective parameters of the first RC-element. It may in particular last until reaching the time constant for the charging and/or discharging behavior of the first RC-element. The (characteristic) time constant for the charging and/or discharging behavior may be calculated in the substitute model as the product of the resistance and the capacitance of the first RC-element. Alternatively or additionally it may be determined by measurement, e.g. by impedance testing (in particular EIS) that may be performed at the manufacturer.

Correspondingly, it is preferentially provided that adapting process of the respective resistance and the respective capacitance of a second or a further RC-element is performed, when the duration of the constant current-interval is longer or equal to a respective (characteristic) time constant for the charging and/or discharging behavior of the second or further RC-element. According to the different dynamics of the RC-elements, a time constant of the second RC-element may be longer than a time constant of the first RC-element and so on. The difference between two time constants of succeeding RC-elements usually amounts to one or two magnitudes. It may depend on the type of energy storage cell, thus in particular on the chemical structure, the design and/or the overall-capacity of the energy storage cell and it may vary in the practice. Furthermore, the values of the time constants may vary during the lifetime of an energy storage cell. By adapting of the substitute model, also the adapted time constants can be calculated.

The adapting of the respective resistance and the respective capacitance of a second or further RC-element mentioned above is preferentially performed during a respective second or further time interval, with this second or further time interval not beginning before a moment of saturation of the previous RC-element. The duration of a second or further time interval may be chosen arbitrarily. It may in particular be as long as is required to perform adapting process of the respective parameters of the second or further RC-element. A second or further time interval may preferentially be lasting until reaching the respective time constant for the charging and/or discharging behavior of the second or further RC-element. The moment of saturation of the previous RC-element may preferentially be defined depending on the time constant of the previous RC-element. In particular, it may be provided that saturation of the previous RC-element is assumed, when a duration, which corresponds to the 4-fold, 5-fold, 6-fold or 7-fold of the time constant of the previous RC-element, has lapsed since the step current. Especially preferred, it is provided that a saturation state is assumed, when the duration mentioned above corresponds to a value between the 5-fold to the 7-fold of the time constant of the previous RC-element.

By selection of the time intervals beginning after saturation of the respective previous RC-element, like mentioned above, it is achieved that the variation of the overall voltage during the respective time interval does not depend on the dynamic behavior of the previous RC-element anymore. That means for a substitute model with three RC-elements that during a second time interval the voltage drop across the first RC-element already has reached a constant maximum value. Thus, the variation of the run of voltage during the second time interval cannot depend on the dynamic behavior of the first RC-element anymore. During the third time interval, both the voltage drop across the first RC-element and the voltage drop across the second RC-element have reached a constant maximum value. Consequently, the measured variations of the overall run of voltage during the third time interval can only be attributed to the dynamic behavior of the third RC-element. As a result, a particularly precise adapting of the parameters of this third RC-element is achievable during the third time interval.

When several succeeding adapting cycles are performed, a very exact determination of all parameters can be performed. For example, at a substitute model with three RC-elements, in a first adapting cycle during the third time interval the parameters of the third RC-element can be determined very exactly. Thereupon, these exactly determined parameters can be used within a second adapting cycle for a very precise simulation of the dynamic behavior of the third RC-element, such that during this second adapting cycle the variation of the voltage drop in the second time interval can be utilized for an exact determination of the parameters of the second RC-element. In the third adapting cycle, then a very exact determination of the parameters of the first RC-element can be performed. In this way, a particularly small model-error and thus a particularly high quality of the substitute model may be achieved.

When only a comparatively short constant-current-interval occurs after a step current, as the case may be, only an adapting of the parameters of the first RC-element or an adapting of the first and the second RC-element may be performed. An adapting of the resistance of the series resistor in the substitute model may preferentially be performed for every adapting cycle.

The method for determination of a maximum allowable load current of an energy storage cell mentioned above is particularly suited for energy storage cells with a high capacity. Furthermore, it is particularly suited for energy storage cells that are operated with frequent load variations, in particular with frequent variations of charging and discharging cycles. Thus, the method is preferentially utilized at energy storage cells of accumulator-units of hybrid and/or electric vehicles and it is dimensioned for this application range.

According to the disclosure, there is provided a method for determination of the performance of an accumulator-unit, wherein the accumulator-unit has several energy storage cells and a substitute model is used for simulation of the charging and/or discharging behavior of each energy storage cell. The maximum allowable load current of the accumulator-unit is calculated from the substitute model. Furthermore, the maximum voltage at appliance of the above mentioned maximum allowable load current of the accumulator-unit is calculated from the substitute model for each energy storage cell. The performance of the accumulator-unit is calculated from the maximum allowable load current of the accumulator-unit and the respective maximum voltages at the energy storage cells.

For the method for determination of the performance of the accumulator-unit it is preferentially likewise provided that the substitute model has a series connection of a series resistor and at least two RC-elements for each energy storage cell, wherein a RC-element is constituted by a parallel connection of each a resistor and a capacitor. Furthermore, it is provided that the respective parameters of the substitute model are adapted for each energy storage cell during the lifetime of the energy storage cells.

In particular, it is provided that the method for determination of the performance of an accumulator-unit is conducted at an accumulator-unit of a vehicle that is used for energizing a propulsion drive. The vehicle in particular is an electric vehicle or a hybrid-vehicle. When the vehicle is an electric vehicle, where a maximum load for the accumulator-unit may occur for longer durations, preferentially a substitute model with three or more RC-elements is utilized. This model is well suited for simulation of longer states with permanent load. At a hybrid-vehicle comparatively shorter permanent load-states are present. It may preferentially be utilized a substitute model with two or more RC-elements. The number of the RC-elements may depend on the type of the utilized storage cells.

The maximum allowable load current of the accumulator-unit may basically be calculated in any arbitrary way. E.g. the respective maximum allowable load current may be determined for each energy storage cell of the accumulator-unit. Subsequently, the maximum allowable load current of the accumulator-unit may e.g. be set to the lowest value of the determined load currents of the energy storage cells. Alternatively, the maximum allowable load current may be set to the value of the fifth or the tenth percentile of the determined load currents of the energy storage cells. It is especially preferred to provide that the maximum allowable load current of the accumulator-unit is set to the value of the maximum allowable load current of the weakest energy storage cell. By this, two advantages are achieved. On the one hand, in a first step, the weakest storage cell may be determined and then in a second step only for this weakest cell a determination of the maximum allowable load current is performed. Thus, a particularly low computing capacity is required. On the other hand, a good balancing is achieved between the requirements of avoiding damages to the energy storage cells and providing the highest overall performance, possible.

The weakest energy storage cell may basically be determined in any arbitrary way. It is preferentially provided that the one cell is defined as the weakest energy storage cell, where a predetermined voltage threshold (voltage-limit) is reached with the respectively lowest current. Thus, e.g. during operation of the accumulator-unit there may be determined the respective runs of voltage and current for each energy storage cell. When the run of voltage at an energy storage cell reaches the predetermined voltage threshold, the thereby occurring current is detected and stored. This may be conducted for all energy storage cells during the lifetime. Then, from a comparison of the detected current values for the energy storage cells, the respective weakest energy storage cell may be determined. This procedure is based on the assumption that the one energy storage cell is weakest, where a combination of a high internal resistance and a high cell voltage is present, which may accordingly lead to high overall voltages at comparatively low current. Alternatively, a weakest energy storage cell of the accumulator-unit may be determined in any other way.

It is preferentially provided that the maximum allowable load current is determined at the weakest energy storage cell by the method for determination of the maximum allowable load current of an energy storage cell mentioned above. Alternatively, the maximum allowable load current may be determined in any other way and it may be pre-known, e.g. from laboratory experiments. In particular, this is advisable at the beginning of the lifetime, when no or only few adapting cycles for the substitute model could be performed. The initial values detected in laboratory experiments may be adapted later by performing the adapting cycles.

The maximum performance of the accumulator-unit may be determined depending on the operating conditions and the type of the accumulator-unit based on different physical parameters, in particular electric parameters. It is especially preferred that the maximum performance is determined as the maximum electric power of the accumulator-unit at appliance of the maximum allowable load current. Thus, it is preferentially provided that the maximum performance of the accumulator-unit is calculated from the maximum allowable load current of the accumulator-unit and the sum of the maximum voltages that emerge at the energy storage cells at appliance of this maximum allowable load current.

The load behavior of an energy storage cell can be different for a state of energy-absorption and a state of energy-output. It may in particular happen that the amount of the maximum allowable load current for a state of energy-output is lower than the one for a state of energy-absorption. Thus, it is preferentially provided that the performance of an energy storage cell and/or an accumulator-unit is calculated separately for a state of energy-absorption and a state of energy-output.

The performance of an energy storage cell or an accumulator-unit under permanent load may considerably differ from the performance under short-load or interval-load, respectively. Thus, it is preferentially provided that the performance of an energy storage cell and/or an accumulator-unit is calculated for different maximum load-durations, separately.

According to the disclosure, a control unit for determination of the performance of an accumulator-unit with two or more energy storage cells is provided, wherein the control unit has detection means for detection of a current at the accumulator-unit and a voltage at each energy storage cell. The control unit is designed to perform one or several steps of the previous described methods.

The control unit is furthermore preferentially designed to determine a maximum operational range of a vehicle based on the performance of the accumulator-unit. Such a control unit is particularly suited for the utilization in electric or hybrid-vehicles, to give the driver the operational range information that is important for his route planning. In particular, the notification of the operational range information is more useful to the driver than notification of a remaining energy capacity of the accumulator-unit.

The control unit preferentially has a limitation device and/or regulation device for limiting the load current of the accumulator-unit. The limitation device is designed to limit the load current of the accumulator-unit in such a way that is stays smaller or equal to the maximum allowable load current of the weakest energy storage cell. By this, damages to the accumulator-unit can be avoided.

A run of current at the accumulator-unit may result randomly from the load behavior of the vehicle. In such a case, it may be provided that the control unit continually monitors the run of current at the accumulator-unit and performs an adapting cycle for the substitute model, when a step current was identified, in particular whenever a step current was identified. Depending on the length of the succeeding stable current level, thus depending on the duration of the constant current-interval, the control unit may only adapt the resistance of the series resistor or additionally the parameters of the first, the second and, as the case may be, the further RC-elements. The longer the constant-current-interval turns out, the more time-intervals can be passed and the more parameters of the respective RC-elements can be adapted.

Alternatively or additionally it may be provided, that the control unit influences one or several electric consumers, which are connected to the accumulator unit. It may in particular be provided that the control unit is designed to influence one or several electric consumers in such a way that a load current with a step current and a succeeding constant current level is produced. Such an influencing may e.g. be performed by activation or deactivation of an air condition, by activation of a sun roof or by influencing the distribution of braking forces between a generator (electric propulsion motor in brake mode) and the mechanical brakes.

A step current may occur in positive or negative direction, thus as a sharp increase or a sharp decrease of the current. It may start from a zero-level of the current or end at a zero-level of the current after the step current. Alternatively, a step current may occur between two arbitrarily different current levels that are not the zero-level.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a schematic diagram showing an energy storage cell;

FIG. 2 is a circuit diagram of a substitute model for an energy storage cell;

FIG. 3A is a circuit diagram of an RC-element;

FIG. 3B is a graph showing a run of voltage at the RC-element due to a step current;

FIG. 4A is a diagram showing a substitute model with three RC-elements;

FIG. 4B is a graph showing calculated runs of voltages due to a step current;

FIG. 5A is a diagram for illustration of an adapting cycle for parameters of the substitute model according to FIGS. 4A and 4B;

FIG. 5B is a diagram for illustration of an adapting cycle for parameters of the substitute model according to FIGS. 4A and 4B; and

FIG. 6 is a schematic diagram showing an accumulator-unit and a control unit.

### DETAILED DESCRIPTION

### First Embodiment

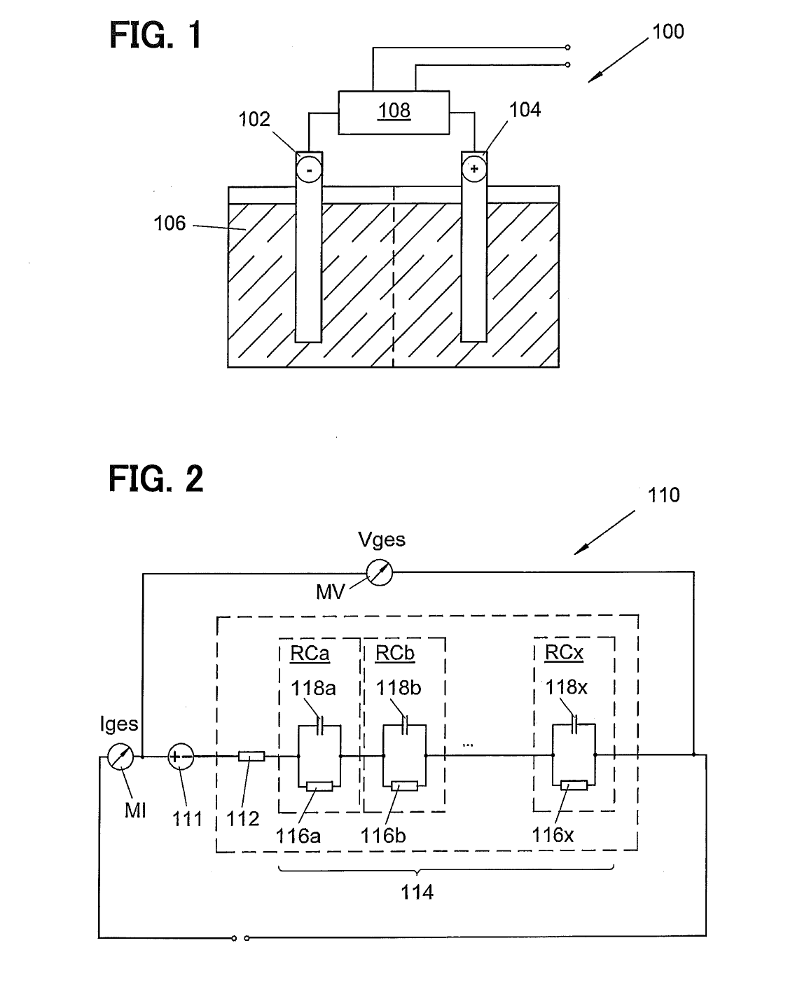

The disclosure relates to a method for determination of a maximum allowable load current (Iₘₐₓ) of an energy storage cell. FIG. 1 shows an energy storage cell 100 in a schematic diagram. The energy storage cell has a negative terminal 102 and a positive terminal 104. Both terminals 102, and 104 are surrounded by an electrolyte 106. The terminals 102, and 104 of the energy storage cell 100 may be connected with other components in a circuit, in particular with electric consumers. Preferentially, a detection unit 108 is arranged at the energy storage cell 100 that e.g. detects a voltage drop across the energy storage cell, i.e. an overall voltage (V_{ges}) across the energy storage cell and, if required, a current (I) at the energy storage cell.

FIG. 2 shows a substitute model 110 for an energy storage cell 100. The substitute model 110 is designed as an electric circuit with standard components. It consists of a series connection of a series resistor 112 with two or more RC-elements (RCa, RCb, . . . , RCx). Each RC-element consists of a parallel connection of a resistor 116 and a capacitor 118. I.e. the first RC-element (RCa) consists of a parallel connection of a first resistor 116a and a first capacitor 118a, the second RC-element consists of a parallel connection of a second resistor 116b and a second capacitor 118b, and so on. In the circuit of FIG. 2 there are furthermore arranged a detection means (MI) for the overall current (I_{ges}) through the substitute model 110 and a detection means (MV) for the overall voltage (V_{ges}) across the substitute model 110. The overall voltage (V_{ges}) corresponds to the sum of all voltage drops (Vₛ, Vₐ, V_{b}, . . . , Vₓ) developing across the series resistor 112 and across the set of RC-elements 114 plus a base voltage (V_{base}) from an ideal voltage source 111. In the following the base voltage will be neglected in describing the simulation model and the adapting process of parameters. It is assumed that a variation of the base voltage may be very low and/or known from other calculations. A variation of the base voltage may in particular depend on the loading status of the energy storage cell. Both the momentary loading status of the energy storage cell and the relation between the loading status and the momentary amount of the base voltage may be known. Thus, in the following it is assumed that the overall voltage (V_{ges}) may be pre-compensated for influences from the loading status of the energy storage cell and thus the base voltage (V_{base}) is neglected. The overall voltage (V_{ges}) is composed of the single voltage drops at the series resistor (Vₛ), at the first RC-element (Vₐ) and at the second RC-element (V_{b}) up to the last RC-element (Vₓ), eventually plus the base voltage (V_{base}), whose influence is not considered relevant for the following description.

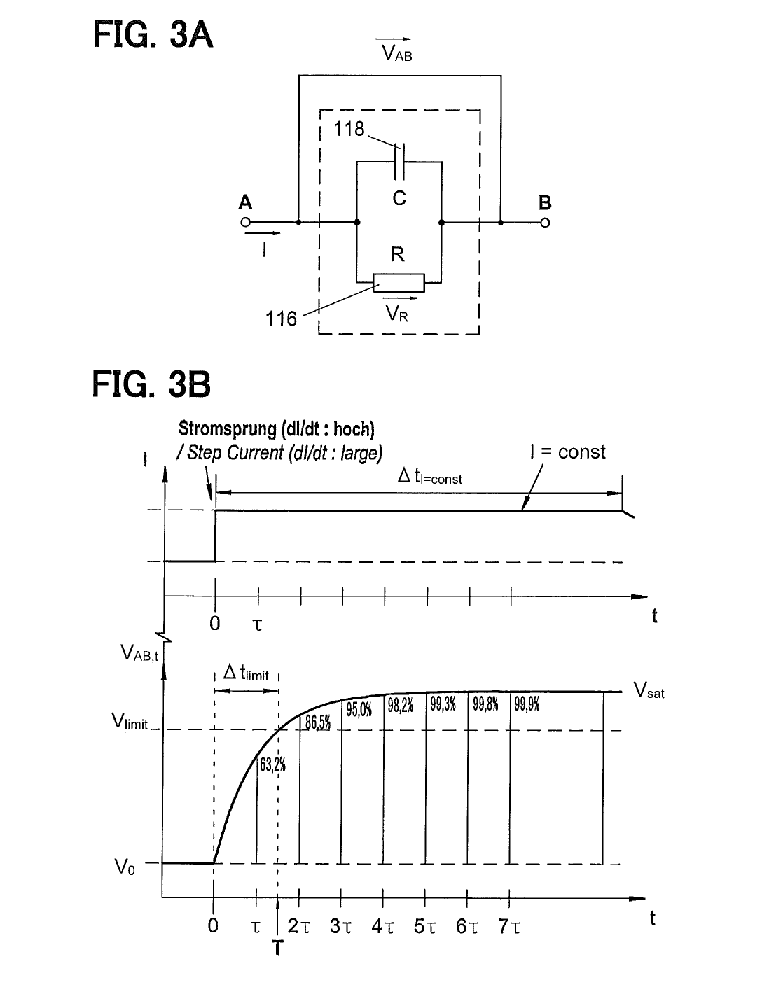

FIG. 3A shows a single RC-element in enlarged depiction. The RC-element is arranged between two contacts (A, B). A current (I) flows through the RC-element. A voltage drop (V_{AB}) may occur across the RC-element, which thus is equal to a measurable voltage between the contacts (A, B).

FIG. 3B shows a characteristic run of the voltage (V_{AB}) as a result of a step current. The upper diagram of FIG. 3B thereby shows the run of a current (I) during a step current. A step current is present, when the current increases during very short time from a first current level to another current level, i.e., when the variation of the current (dI/dt) has a very large amount. For electric vehicles or hybrid vehicles a step current may e.g. comprise a current change of 5 A (Ampere), 10 A, 20 A or 50 A. It may in some case be even much higher and amount to 300 A, 500 A or more. The current change may be present as a current increase or a current decrease (not depicted). For other applications different values may be present. The run of current (I) in FIG. 3B has a section with a steady current value kept for a longer period (Δt_{Iconst}) after the sharp increase of the current. Such a section will be designated in the following as a constant current level (I=const).

In the second diagram of FIG. 3B a run of the voltage (V_{AB}) as a result of the step current with the succeeding constant current level is depicted. The first and the second diagram of FIG. 3B are both related to the same reference axis for the time (t). The time (t) is counted originating from a moment (t=0) that corresponds to the moment of the step current. On the time axis, multiples of a (characteristic) time constant (τ) for the charging and/or discharging behavior of the RC-element of FIG. 3A are depicted.

In the following, it is assumed for the matter of simplicity that the voltage drop (V_{AB}) at the moment (t=0) of the step current has a constant value, i.e. (V₀=const). This is the case, e.g., when the current through the RC-element before the step current is equal to zero (I_{t<0}=0) or when it had a constant value (I_{t<0}=const.) for a longer period. Furthermore, it is assumed for the matter of simplicity, that the capacitor 118 in the RC-element is empty at the moment of the step current (t=0), i.e. that it does not contain any electric charge.

An empty capacitor does not wield any resistance against the input of electrons. I.e., the effective resistance (r_{C}) of the capacitor 118 at the moment of the step current is zero. As soon as a current (I) flows through the capacitor 118, electric charge is put into it and an electric field is produced that counteracts the input of further electrons. As a result, the effective resistance (r_{C}) of the capacitor 118 will increase over time. When the capacitor 118 is saturated, its effective resistance is infinitely high (r_{C}=∞).

The current (I) that flows through the RC-element will be distributed over the resistor 116 and the capacitor 118 at each moment according to the relation of their resistances (R, r_{C}). This means, at the moment (t=0), when the effective resistance (r_{C}) of the capacitor 118 is zero, the whole current will flow through the capacitor 118. During the further process, the effective resistance (r_{C}) of the capacitor 118 will increase, with the result that the current (I) will distribute itself over the capacitor 118 and the resistor 116. When the capacitor 118 is saturated, thus when its effective resistance (r_{C}=∞) is (approximately) infinitely high, the whole current (I) will flow through the resistor 116.

The voltage drop (V_{AB}) across the RC-element is determined by the overall resistance (R_{ges}) of the RC-element. The overall resistance (R_{ges}) of the RC-element of FIG. 3A depends on the saturation state of the capacitor 118, thus on the actual amount of the effective resistance (r_{C}). Consequently, following relation (1) is valid:

$$\frac{1}{Rges} = \frac{1}{R} + \frac{1}{rc} \qquad ( 1 )$$

It can be converted to following relation (2):

$$Rges = \frac{R \cdot rc}{R + rc} \qquad ( 2 )$$

At the time (t=0), the overall resistance (R_{ges}) is equal to zero. When the capacitor 118 is saturated (r_{C}=∞), the overall resistance (R_{ges}) of the RC-element is equal to the resistance (R) of the resistor 116. In-between, the effective resistance (r_{C}) exponentially increases.

The run of the voltage drop (V_{AB}) across the RC-element according to FIG. 3A is defined according to the following equations (3) and (4):

V_{AB}(t)=I·R·(1−e^{-t/τ}) (3)

with:

τ=RC (4)

This run of the voltage (V_{AB}) is shown in the second diagram of FIG. 3B. The (characteristic) time constant (τ) indicates, after which duration the voltage (V_{AB}) will reach a share of 63.2% (=1-e⁻¹=1-EXP(−1)) of the saturation voltage (Vₛₐₜ) at the RC-element. The saturation voltage (Vₛₐₜ) at the RC-element corresponds to the product of the maximum achievable overall resistance (R_{ges}=R) of the RC-element with the current (I). The saturation voltage (V_{AB}=Vₛₐₜ) is present at a fully saturated capacitor 118. It corresponds to the product of the resistance (R) of the resistor 116 with the current (I). Thus, the previous equation can be written as following equations (5) and (6):

V_{AB}(t)=Vsat·(1−e^{-t/τ}) (5)

Vsat=I·R (6)

In the second diagram of FIG. 3B it is indicated by numbers, what share of the saturation voltage (Vₛₐₜ) the voltage drop (V_{AB}) will have at specific moments. At (t=2τ), e.g. the share is equal to 86.5%. At (t=5τ) the share is 99.3% and at (t=7τ) the share is 99.9%. The saturation state of the RC-element may be defined depending on the characteristic time constant (τ). It may in particular be indicated as a manifold of the time constant (e.g. as saturation at 4τ, 5τ, 6τ, 7τ).

When the saturation voltage (Vₛₐₜ) is set to the maximum permissible voltage (Vₘₐₓ) at the RC-element, the voltage drop (V_{AB}) at any arbitrary moment (t) after the step current can be calculated according to the following formula (7):

V_{AB}(t)=Vmax·(1−e^{-t/τ}) (7)

In this formula, the maximum voltage (Vₘₐₓ) is the voltage, that would be reached, when the RC-element is operated with the allowable current (Iₘₐₓ) until the complete saturation of the RC-element. This maximum voltage (Vₘₐₓ) corresponds to the product of the maximum current (Iₘₐₓ) with the resistance (R) of the capacitor 116.

Vmax=Imax·R (8)

At a moment (t=T), which is situated before the saturation of the RC-element, i.e. with (T<7τ) and (V_{AB}(T)<Vₘₐₓ), the voltage (V_{AB}) at the RC-element reaches a predefined threshold (Vₗᵢₘᵢₜ). Until this moment, the time interval (Δtₗᵢₘᵢₜ) has lapsed. Accordingly, the following equation (9) is valid:

Vlimit=Imax·R·(1−e^{-T/RC}) (9)

When the variation of the voltage since the moment (t=0) is related to the initially measured voltage (V₀) this equation can be converted to following equation (10):

ΔV_{AB}(T)=Vₗᵢₘᵢₜ−V0=Imax·R·(1−e^{-T/RC}) (10)

This equation can be solved for the maximum current (Iₘₐₓ), such that emerges following equation (11):

$$I max = \frac{V limit - V 0}{R \cdot ( 1 - {e}^{- T / RC} )} . \qquad ( 11 )$$

Thus, it is possible to determine the maximum current (Iₘₐₓ) that would occur at complete saturation of the RC-element by calculation. For this, it is required that a step current with a succeeding stable current level in the run of current across the RC-element is detected, the initial voltage (V₀) at the moment (t=0) of the step current is detected and the time (T) is detected, at which the voltage across the RC-element has reached a predefined threshold (Vₗᵢₘᵢₜ). When the capacity (C) of the capacitor 118 and the resistance (R) of the resistor 116 are known, from these values the maximum current (Iₘₐₓ) can be calculated.

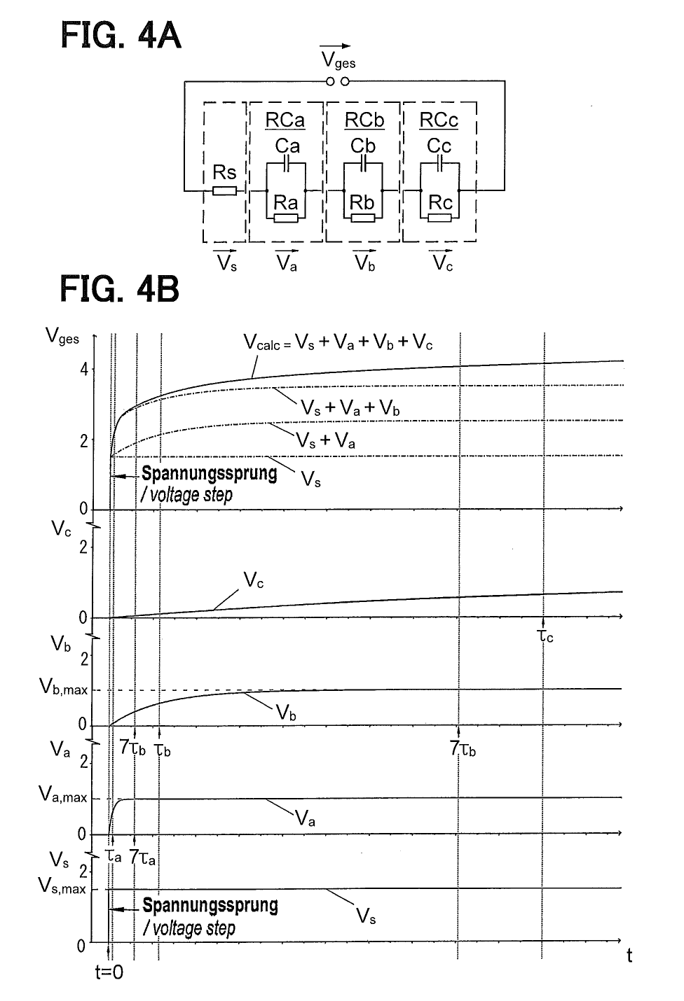

The described calculations for the RC-element of FIG. 3A can be transferred to a circuit with several RC-elements. FIG. 4A shows a preferred embodiment of the substitute model 110. It has a series resistor with a resistance (Rs) and three RC-elements (RCa, RCb, RCc). The respective resistances of the resistors in the three RC-elements are designated as (Ra, Rb, Rc). Correspondingly, the capacitances of the three RC-elements are designated with (Ca, Cb, Cc). The overall voltage (V_{ges}) across the substitute model 110 is composed by addition from the single voltage drops across the series resistor (Vₛ) and the RC-elements (Vₐ, V_{b}, V_{c}). Thus, following relation (12) is valid:

Vges=Vs+Va+Vb+Vc (12)

As it was explained beforehand, in practice there may also be added a base voltage (V_{base}) from an ideal voltage source 111, which is neglected for the matter of simplified description. The single voltage drops (Vₛ, Vₐ, V_{b}, V_{c}) can be calculated according to the following relations (13), (14), (15) and (16):

Vs=I·Rs (13)

Va=I·Ra·(1−e^{-t/RaCa}) (14)

Vb=I·Rb·(1−e^{-t/RbCb}) (15)

Vc=I·Rc·(1−e^{-t/RcCc}) (16)

According to the previous explanations, at a moment (t=T), at which the overall voltage (V_{ges}) across the substitute model reaches a threshold (Vₗᵢₘᵢₜ), following relation (17) is valid:

Vges=Vlimit−V0=Vs+Va(T)+Vb(T)+Vc(T) (17)

When putting in the respective parameters of the substitute model, namely the resistance (Rs) of the series resistor 112, the resistances (Ra, Rb, Rc) of the respective resistors and the capacitances (Ca, Cb, Cc) of the respective capacitors of the RC-elements, following relation (18) is turned out:

$$V limit - V 0 = IRs + IRa ( 1 - {e}^{- T / RaCa} ) + IRb ( 1 - {e}^{- T / RbCb} ) + IRc ( 1 - {e}^{- T / RcCc} ) \qquad ( 18 )$$

This may again be converted to the following equation (19):

$$I max = \frac{V limit - V 0}{\begin{matrix}Rs + Ra ( 1 - {e}^{- T / RaCa} ) + \\ Rb ( 1 - {e}^{- T / RbCb} ) + Rc ( 1 - {e}^{- T / RcCc} )\end{matrix}} \qquad ( 19 )$$

As a consequence, a maximum allowable current level (Iₘₐₓ) at an energy storage cell 100 can be determined from the known parameters (Rs, Ra, Rb, Rc, Ca, Cb, Cc) of the substitute circuit 110, a measured initial voltage (V₀) at the moment (t=0) of the step current and the time (T), at which a predefined threshold (Vₗᵢₘᵢₜ) is reached.

The maximum allowable load current (Imax) is preferentially defined as the maximum current value by which the energy storage cell can be operated continuously for a time period (T), such that the overall voltage across the energy storage cell will be kept smaller or equal to a predefined threshold (Vₗᵢₘᵢₜ). The predefined threshold preferentially is a maximum load voltage (Vₗᵢₘᵢₜ) that can be endured by the energy storage cell. This load voltage may be pre-known, it may in particular be indicated by the manufacturer.

In FIG. 4B, characteristic runs of voltages are depicted at a substitute model 110 according to FIG. 4A. The runs of voltages result from the same step current. The voltage drop (Vₛ) at the series resistor 112 has a sharp increase to a constant maximum value (V_{s,max}) (lowermost diagram of FIG. 4B).

The first RC-element (RCa) has the fastest dynamic behavior (second diagram from bottom in FIG. 4B). The voltage drop (Vₐ) reaches a share of 63.2% of the maximum possible voltage drop (V_{a,max}) at the first RC-element within a relatively short time (until t=τₐ). After a duration (e.g. t=5τₐ t=7τₐ), the first RC-element (RCa) is saturated.

The second RC-element (RCb) has a somewhat slower dynamic behavior (middle diagram of FIG. 4B). At a moment (t=τ_{b}), that is situated considerably after the moment of a saturation of the first RC-element (t=7τₐ), the voltage drop (V_{b}) across the second RC-element (RCb) reaches a share of 63.2% of the maximum possible voltage drop (V_{b,max}). A saturation of the second RC-element is present at the moment (t=7τ_{b}), at latest.

The third RC-element (RCc) has the slowest dynamic behavior (second diagram from top in FIG. 4B). The voltage drop (V_{c}) across the third RC-element (RCc) reaches a share of 63.3% of the maximum possible voltage drop for the third RC-element at a moment (t=τ_{c}). Thereby, the time constant (τ_{c}) of the third RC-element is considerably larger than the 7-fold of the time constant (τ_{b}) of the second RC-element (τ_{c}>7τ_{b}).

In the uppermost diagram of FIG. 4B, accumulated runs of voltages at the substitute model 110 according to FIG. 4A are depicted. The calculated run (V_{calc}) of the overall voltage at the substitute model 110 is thus composed by the respective values of the voltage drops (Vₛ, Vₐ, V_{b}, V_{c}) at the series resistor 112 and the RC-elements (RCa, RCb, RCc).

It is apparent from the diagrams, that the dynamic behavior of the first RC-element (RCa), i.e. the variations of the voltage drop (Vₐ) across the first RC-element (RCa), only has a relevant influence to the run of the calculated overall voltage (V_{calc}), at the beginning. As soon as the first RC-element (RCa) is saturated (t≧7τₐ), the run of the calculated overall voltage does only depend on the variations of the voltage drops (V_{b}, V_{c}) at the second and third RC-element (RCb, RCc).

Accordingly, the dynamic behavior of the second RC-element (RCb) only has an influence to the variations of the calculated overall voltage (V_{calc}) until the moment of its saturation (t=7τ_{b}). After the saturation (t≧7τ_{b}) of the second RC-element (RCc), the variations of the calculated (V_{calc}) only depend on the run of the voltage drop (V_{c}) of the third RC-element (RCc). These relations can be utilized for adapting of the substitute model in an advantageous way.

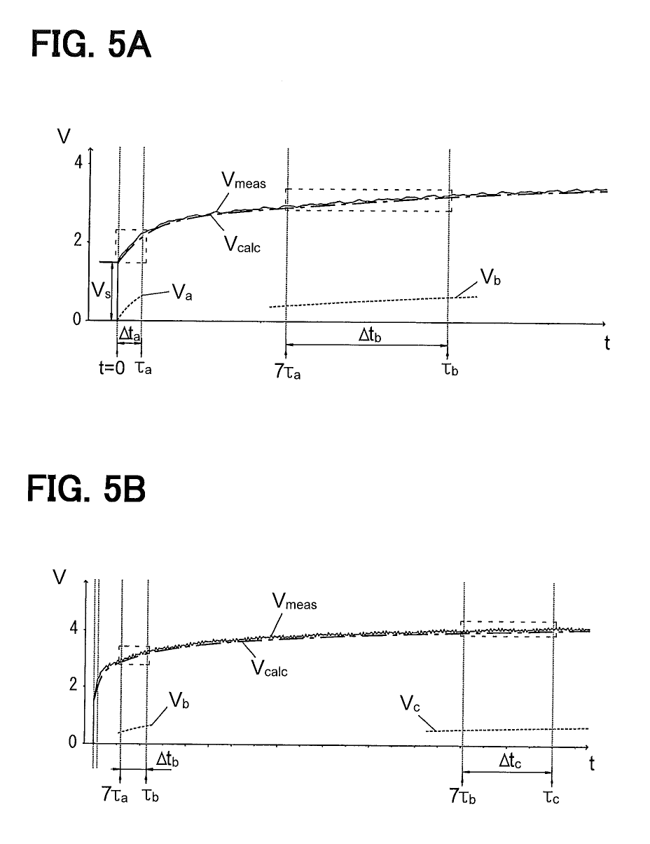

FIGS. 5A and 5B show diagrams, in which a measured run of voltage (Vₘₑₐₛ) at an energy storage cell 100 and a calculated run of voltage (V_{calc}) of a substitute model are compared. Both runs of voltages (V_{calc}, Vₘₑₐₛ) are based on the same measured run of current with the step current (dI/dt:large) and a succeeding stable current level (I=const) during a constant−current-interval (Δt_{Iconst}).

The measured run of voltage (Vₘₑₐₛ) is preferentially detected directly by a sensor. Alternatively, the measured run of voltage (Vₘₑₐₛ) may be a pre-compensated run. Pre-compensation may in particular be performed for computational elimination of voltage changes that occur during a constant-current-interval due to a change in the current loading status of the energy storage cell.

The overall voltage at an energy storage cell may basically increase by a known, in particular by a mostly linear relation to the loading status of the energy storage cell. The relation between the loading status and a thereby caused voltage variation may e.g. be stored in a map. In the following pre-compensation of the measured run of voltage (Vₘₑₐₛ) will be explained exemplarily. At the moment of the occurrence of a step current (t=0), the momentary overall voltage may be detected and the momentary loading state of the energy storage cell may be known. During the succeeding constant current level (0≦t≦7τ_{c}) the loading status of the energy storage cell may be detected depending on the electric current amount and time. In particular, an amount of energy (electric charge) put into the cell during the constant-current-interval may be calculated, in particular by integration of the electric current (I) over time (t). From this a momentary loading status of the energy storage cell can be calculated. During the constant-current-interval at any point in time a voltage change due to the change of the momentary loading status can be determined from the known relation, which may be stored in any organized data structure, such as a map, a mathematical function or a lookup-table. This voltage change can be subtracted from the voltage that is detected by the sensor. By this, the pre-compensated measured voltage (Vₘₑₐₛ) is obtained. The voltage change due the loading status of the cell may directly correspond to the variation of the base voltage (V_{base}) described above.

Example: At the occurrence of a step current the loading status of the energy storage cell may be 10%. At some later point in time during the constant-current-interval, the loading status may have increased to 20%. A voltage change due to the changed loading status can be determined from a lookup-table and it may have a value of 0.095 V (Volts) at this point of time. This value of the voltage change can be subtracted from the value of the overall voltage measured by a sensor, from which at this point in time the pre-compensated value of the measured run of voltage (Vₘₑₐₛ) is obtained. This method can be performed for any arbitrary point in time after the step current.

If pre-compensation shall be applied may depend on the ratio between the overall capacity of the energy storage cell and the electric energy put into the cell during a constant-current-interval. Pre-compensation is particularly meaningful, when the overall capacity of the energy storage cell is comparatively small, such that the loading status with change significantly during the period of a usual constant-current-interval.

For the depiction in FIGS. 5A and 5B it is assumed, that the constant-current-interval (Δt_{Iconst}) is larger than the time constant (τ_{c}) for the charging and/or discharging behavior of the third RC-element (RCc). Thus, in FIGS. 5A and 5B an adapting cycle is performed for all parameters (Rs, Ra, Rb, Rc, Ca, Cb, Cc) of the substitute model 110 according to FIG. 4A.

In the following for explanation of the diagrams, beside the term current step, there will be used the term voltage step. At a moment (t=0) the measured (and eventually pre-compensated) run of voltage (Vₘₑₐₛ) and the calculated run of voltage (V_{calc}) both have a voltage step, i.e. a sharp rise of the voltage (dV/dt:large). By comparison of the voltage steps at the measured run of voltage (Vₘₑₐₛ) and at the calculated run of voltage (V_{calc}) an adapting of the resistance (Rs) of the series resistor 112) can be performed, in particular from the difference (ΔV) between the amounts of the respective reached voltage levels at the moment (t=0) at the end of the voltage step.

A first time interval (Δta) for adapting process of parameters of the substitute model 110 begins at the moment (t=0) of the occurrence of a step current. It may end at any suitable moment after completion of adapting the parameters for the first RC-element. The first time interval may for example end with reaching the time constant (τₐ) of the first RC-element. In the first time interval (Δta), a difference (ΔV) between the measured run of voltage (Vₘₑₐₛ) and the calculated run of voltage (V_{calc}) is preferentially used exclusively for adapting process of the resistance (Ra) and the capacity (Ca) of the first RC-element (RCa). It is to be understood, that not the whole runs of voltages (Vₘₑₐₛ, V_{calc}) have to be compared, although this may be advantageous. It may be sufficient that only some measurement points during the first time interval are compared mathematically to the voltage calculations from the simulation model, in particular using the parameters of the first RC-element to be adapted. As such, by using the parameters of the simulation model, a best fit curve can be calculated, which may be compared to some measurement points. For the sake of simplified description, the wording “comparison of the runs of voltages” is used as it corresponds to the depiction in the drawings. The person skilled in the art understands that he may transform this description into suitable actions, in particular into suitable calculation methods for performing the adapting cycles. According to FIG. 5A, the first time interval (Δta) lasts from the occurrence of the step current (t=0) until reaching the characteristic time constant (τₐ) of the first RC-element (RCa).

During the first time interval (Δta) a considerable variation of the voltage drop (Vₐ) across the first RC-element (RCa) is present, whereas the variations of the voltage drops (V_{b}, V_{c}) at the second and third RC-elements (RCb, RCc) are comparatively low. From the diagrams of FIG. 5A it is apparent that the run of the measured voltage (Vₘₑₐₛ) and the run of the calculated voltage (V_{calc}) are essentially parallel to the run of the voltage drop (Vₐ) at the first RC-element (RCa). Variations of the voltage drops (V_{b}, V_{c}) at the second or third RC-element can be neglected or preferentially calculated during the first time interval (Ata) from the substitute model 110. These variations of the voltage drops (V_{b}, V_{c}) are very low in comparison to the variations of the voltage drop (Vₐ) at the first RC-element (RCa). During adapting process of the parameters (Ra, Ca) of the first RC-element (RCa) in the first time interval (Δta), it can be assumed that the calculated runs of the voltage drops (V_{b}, V_{c}) are correct. Thus, it is allowable for regression calculations, to correlate the variations of the measured voltage (Vₘₑₐₛ) exclusively with the variations of the calculated voltage drop (Vₐ) at the first RC-element (RCa). From the differences (ΔV) during the first time interval (Δta), thus an adapting process of the parameters (Ra, Ca) of the first RC-element can be calculated, wherein the parameters (Rb, Rc, Cb, Cc) of the second and third RC-elements are assumed to be correct. If the parameters (Rb, Rc, Cb, Cc) of the second and third RC-elements (RCb, RCc) in fact do have an error, an concatenation of errors may eventually occur, at which, however, the errors of the parameters (Rb, Rc, Cb, Cc) of the second and third RC-elements (RCb, RCc) lead to an error at the adapting process of the parameters (Ra, Ca) of the first RC-element (RCa) in an considerably reduced extent.

The first time interval preferentially begins with the occurrence of a step current. Alternatively the first time interval may begin a short time after the occurrence of a step current. In such a case it may be avoided that a noisy segment in the measured run of voltage will be used for adapting process, which could cause an adapting error. Again alternatively the first time interval may begin directly with occurrence of a step current, wherein the first measurement values to be sampled during the first time interval will be checked for inadmissible noise. If a noisy or too noisy segment is detected within the sample, those values may be rejected from being used for the parameter adapting process.

A second time interval (Δtb) preferentially follows the first time interval (Δta) with an intermediate time duration. That means, between the end of the first time interval (Δta) and the beginning of the second time interval a time duration may be present, which is not assigned to any of the time intervals.

After the end of the first time interval (Δta), preferentially no further adapting process of parameters is performed until a saturation state of the first RC-element (RCa) is reached. The saturation state is preferentially defined as a moment of reaching the 5-fold or the 7-fold of the first time constant (τₐ) (t=5τₐ up to t=7τₐ). Alternatively, another moment can be assumed as the saturation state. The second time interval (Δtb) preferentially begins from the moment of saturation of the first RC-element (RCa). It may last for any arbitrary duration. It may e.g. last until reaching the second time constant (t=τ_{b}) of the second RC-element (RCb). Thus, the second time interval (Mb) covers a duration, wherein variations of the measured and the calculated runs of voltages (Vₘₑₐₛ, V_{calc}) cannot be attributed to a variation of the voltage drop of the first RC-element (RCa) anymore. The voltage drop (Vₐ) has reached its saturation value (V_{a,sat}) and does not contribute to variations of the overall voltage anymore.

According to above explanations, it is assumed that during the second time interval (Δtb) essentially the runs of voltages (Vₘₑₐₛ, V_{calc}), and thus also the difference (ΔV) between the measured voltage (Vₘₑₐₛ) and the calculated voltage (V_{calc}), are attributable variations of the voltage drop (V_{b}) at the second RC-element (RCb). Consequently, in the second time interval (Mb) preferentially exclusively the resistance (Rb) and the capacitance (Cb) of the second RC-element (RCb) are adapted. It is thereby preferentially assumed, that the parameters (Ra, Rc, Ca, Cc) of the first and third RC-element (RCa, RCc) are correct. Like explained above, the person skilled in the art may choose a suitable way for performing the adapting process, e.g. calculation of a best fit curve based on the parameters to be adapted. If required, parameters (Ra*, Ca*) for the first RC-element (RCa) can be considered that were already adapted during the first time interval (Ata). From the diagrams of FIG. 5A it is again apparent, that the runs of the measured voltage (Vₘₑₐₛ) and the calculated voltage (V_{calc}) are essentially parallel to the run of the voltage drop (V_{b}) at the second RC-element (RCb).

The diagram of FIG. 5B corresponds to the diagram of FIG. 5A and has a time axis (t) in downscaled depiction, such that a longer temporal duration (t=0 until t=τ_{C}) is shown on the abscissa. In the diagram of FIG. 5B, also a third time interval (Δtc) for the adapting process of the parameters (Rc, Cc) of the third RC-element (RCc) is depicted. The third time interval (Δtc) again preferentially begins at a saturation state of the (previous) second RC-element (RCb), i.e. for example at (t=5τ_{b}) or at (t=7τ_{b}). It preferentially lasts until reaching the value of the third time constant (τ_{c}) for the charging and/or discharging behavior of the third RC-element (RCc). Analogously to the previous explanations, it is assumed that a voltage drop (Vₐ) at the first RC-element (RCa) and a voltage drop (V_{b}) and the second RC-element (RCb) have reached a saturation value (V_{a,sat} and V_{b,sat}). Thus, a variation of a run of voltage (Vₘₑₐₛ, V_{calc}) during the third time interval (Δtc) may exclusively be attributed to a voltage drop (V_{c}) at the third RC-element (RCc). A difference (ΔV) between the run of a measured voltage (Vₘₑₐₛ) and the run of a calculated voltage (V_{calc}) is thus preferentially utilized in the third time interval (Δtc) exclusively for adapting process of the resistance (Rc) and the capacitance (Cc) of the third RC-element (RCc).

During the third time interval (Δtc), a particularly exact adapting process of the parameters (Rc, Cc) of the third RC-element (RCc) can be performed. In the third time interval (Δtc), influences from voltage variations at the previous RC-elements are excluded. Consequently the variation of the overall voltage actually depends only on the variation of the voltage drop (V_{c}) at the third RC-element (RCc). This means that the adapting of the parameters (Rc, Cc) of the third RC-element (RCc) are independent from eventual errors of the parameters (Ra, Rb, Ca, Cb) of the first or second RC-elements.

In the following, it will be described, how a particularly high model quality can be achieved by the perform of several adapting cycles.

In a first adapting cycle, the parameters (Rc, Cc) of the third RC-element (RCc) can be adapted particularly exactly, as they do not depend on eventual errors of the parameters of previous RC-elements. For a subsequent adapting cycle, the exactly adapted parameters (Rc*, Cc*) of the third RC-element (RCc) can be utilized for particularly exact calculation of the variations in the voltage drop (V_{c}) at the third RC-element (RCc) during a first and a second time interval (Δta) and (Δtb). In doing so, the effect of an error concatenation is even more reduced, which could be caused by eventual errors (Rb, Rc, Cb, Cc) during the adapting in the first time segment. Consequently, adapting of the parameters (Ra, Rb, Ca, Cb) of the first and second RC-elements (RCa, RCb) can be improved, when there could be performed a precise adapting of the parameters of the third RC-element during a previous adapting cycle. Likewise, a particularly precise adapting of the parameters of the second RC-element (RCb) will have a positive effect to the adapting quality of the parameters of the first RC-element (RCa) in a subsequent adapting cycle.

The overall quality of the substitute model 110 may thus be improved by performing application cycles as often as possible and when as many application cycles as possible will be performed for long constant-current-intervals (Δt_{Iconst}), at which also the parameters of a third or, if applicable, further RC-elements are adapted. That means, there is a positive effect to the quality of the substitute model 110, when there occurs a step current as often as possible with a succeeding stable current level lasting for as long as possible in the measured run of current during the lifetime of an energy storage cell 100 or accumulator-unit 124. To achieve a model quality as high as possible, it may preferentially be provided (according to the use case situation of the energy storage cell 100 or the accumulator-unit 124 that electric consumers are influenced by a control unit, in order to artificially produce a run of current with a step current and a long lasting stable current level.

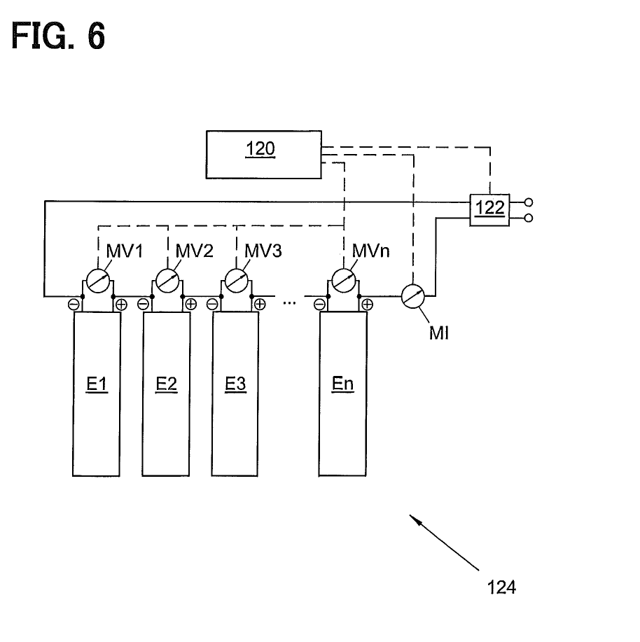

FIG. 6 shows a schematic view of an accumulator-unit 124 with several energy storage cells (E1, E2, . . . , En). Each of the energy storage cells (E1, . . . , En) may correspond to the energy storage cell 100 of FIG. 1 with relation to the structure. The energy storage cells (E1, . . . , En) are connected in series. A minus-terminal (−) of the first energy storage cell (E1) and a plus-terminal (+) of the last energy storage cell (En) are preferentially connected with contacts for attaching electric consumers (like a propulsion engine, an air condition, a sun roof etc.). In FIG. 6, a control unit 120 is depicted that is assigned to an accumulator 124. The control unit 120 preferentially has detection means (MV1, MV2, . . . , MVn) for detection of a voltage (Vi) at each energy storage cell (Ei), i.e. an overall-voltage (V_{ges}) as a measured voltage (Vₘₑₐₛ). In particular, it may be provided that a detection unit (MVi) for measurement of a voltage drop (Vi) is provided between a minus-terminal and a plus-terminal of each energy storage cell (Ei). For the case of a series connection of the energy storage cells (E1, . . . , En), the current (I) is identical at each of the energy storage cells, such that preferentially only one detection device (MI) is provided for detection of the current (I), which may e.g. be connected in series with the energy storage cells (E1, . . . , En). Alternatively, any arbitrary different number and/or design of detection means can be provided.

The control unit 120 is preferentially designed to perform a method for determination of a maximum allowable load current of an energy storage cell (Ei) during its lifetime. It is further preferentially designed to perform a method for determination of the performance of an accumulator-unit 124. In particular, it may be provided that a method for determination of a maximum allowable load current of an energy storage cell (Ei) is performed within a method for detection of the performance of the accumulator-unit 124.

The control unit (controller) is an electrical control unit (ECU). The controller has at least one processing unit (CPU) and at least one memory device (MMR) provided as a storage medium which stores a set of program and data. The controller is provided with a microcomputer having the storage medium readable by a computer. The storage medium is a non-transitory storage medium which stores a program readable by the computer. The storage medium can be provided by a device, such as a solid state memory device and a magnetic disc memory. The controller is provided with one computer, or a set of computer resources linked by a data communication device. The program, when executed by the controller, makes the controller to function as devices described in this specification, and makes the controller to perform methods described in this specification. The controller provides a plurality of various elements. At least a part of those elements may be called as means for performing functions, and, in another aspect, at least a part of those elements may be called as structural blocks or modules.

It is particularly preferred that the control unit 120 and the accumulator-unit 124 are arranged on a vehicle, in particular on an electric vehicle or a hybrid-vehicle. In such a case, the control unit 120 is preferentially designed to determine the maximum operational range of the vehicle from the performance of the accumulator-unit 124.

In order to achieve the best possible quality of the substitute model 110, as it was mentioned above, it is preferentially provided that the control unit 120 may influence one or several electric consumers, which are connected with the accumulator-unit 124. Influencing may particularly be performed such that the electric consumers control their energy consumption singularly or in common in such a way that a defined run of current (I) is produced at the accumulator-unit 124. In particular it may be provided that such influencing is created that a load current (I) with a step current and a succeeding stable current level (I=const) is produced. Furthermore, it may be provided that the stable current level is generated during an adjustable constant-current-interval (Δt_{Iconst}).

For an electric vehicle or a hybrid-vehicle, it may for example be provided that during a braking phase of the vehicle a load distribution between a propulsion engine (electric motor), which is operated in the generator mode, and mechanical brakes of the vehicles is regulated such that the accumulator-unit 124 is supplied with a constant charging current (I=const). In doing so, a constant current level can be produced by suitable influencing of the propulsion engine and the mechanic braking installation during the whole braking phase of the vehicle, thus until it is standing still. Alternatively or additionally, during a standstill of the vehicle or while driving with constant velocity, an electrically operated air condition or any other electric consumer with a not insignificant power consumption can be activated or deactivated. Also by this, a step current with a succeeding stable current level may be produced as a discharge current at the accumulator-unit 124.

The control unit 120 preferentially has a limitation device 122 for limiting the load current (I) of the accumulator-unit 124. The load current may be a charging-current (for charging the accumulator-unit) or a discharging-current (for discharging the accumulator-unit). The limitation device 122 may be designed in any arbitrary way. In the practice, different circuits are known, by which a load current limitation may be achieved both or either for a charging-current and a discharging-current of an accumulator-unit 124. The limitation device 122 is preferentially designed such that the load current (I) of the accumulator-unit 124 stays smaller or equal to the maximum allowable load current of the accumulator-unit, in particular of the weakest cell (Ei*). As it was explained above, the weakest energy storage cell (Ei*) may be determined in any arbitrary way. In particular, the one energy storage cell (Ei) may be assumed as the weakest cell (Ei*), where a predetermined voltage threshold (Vₗᵢₘᵢₜ) is reached with the lowest current. Then, by means of the method described above, the maximum allowable load current (I_{i,max}*) may be determined for the weakest energy storage cell (Ei*), which may then also be set as the maximum allowable load current (Iₘₐₓ*) for the whole accumulator-unit 124.

Preferentially, a maximum performance of the accumulator-unit 124 is defined as the maximum electric power (Pₘₐₓ). The maximum performance (Pₘₐₓ) of the accumulator 124 is preferentially calculated from a maximum allowable load current (Iₘₐₓ*) of the accumulator-unit 124 and the maximum voltages (V_{i,max}*), which are developing at the energy storage cells (Ei) for this maximum allowable load current (Iₘₐₓ*) of the accumulator-unit 124. The maximum electric power (Pₘₐₓ) may be expressed by following formula (20):

$$P max = {\sum }_{i}^{n} ( V max , i ) * {I}^{*} max \qquad ( 20 )$$

A maximum allowable load current at an energy storage cell or a maximum performance of an accumulator-unit are preferentially determined separately for a charging-current and a discharging-current. Furthermore preferentially, they are calculated separately for different time intervals of permanent load to the energy storage cell or the accumulator-unit, respectively, with the maximum allowable load current. In particular, a calculation may be provided for permanent maximum load intervals (t_{MaxLoad}) with durations between 0 and 20 seconds, e.g. for durations of 0.5 seconds, 5 seconds and 15 seconds. Alternatively, according to the type of the energy storage cell and the use case, other suitable permanent maximum load intervals (t_{MaxLoad}) may be provided.

In this embodiment, the storage cells Ei and the accumulator 124 (battery) is simulated by a substitute model 110 which is provided by a mathematical model which represents a series connected plurality of RC elements. The mathematical model is stored in the memory device, by storing at least one mathematical formulae, map or table and a plurality of parameters. The disclosed method is implemented by a computer.

Adapting step is performed by a set of program executed by a CPU. The adapting step is performed based on a measured behavior of the storage cells Ei and a calculated behavior of the substitute model 110, which both are at least temporarily stored in the memory, in order to change values of the parameters stored in the memory.

Calculating steps are performed by a set of program executed by a CPU. A maximum current calculating step is performed to calculate and renew a maximum allowable load current stored in the memory by using the substitute model 110 defined by parameters that is adapted at least once in the previous adapting step. A maximum voltage calculating step is performed to calculate maximum voltages created on the storage cells Ei respectively when the maximum allowable load current is applied to the storage cells Ei by using the substitute model 110 stored in the memory device. A performance calculating step is performed to calculate and store a performance of the accumulator unit 124 in the memory device by using the maximum allowable load current of the accumulator unit 124 and the maximum voltages of the storage cells Ei which both calculated and stored in the memory device.

### Other Embodiment

While the present disclosure has been described with reference to embodiments thereof, it is to be understood that the disclosure is not limited to the embodiments and constructions. The present disclosure is intended to cover various modification and equivalent arrangements. In addition, while the various combinations and configurations, which are preferred, other combinations and configurations, including more, less or only a single element, are also within the spirit and scope of the present disclosure.

Variations of the disclosure are possible in various ways. In particular, the described and depicted features of the single embodiments may be combined with each other, replaced by each other, complemented or omitted in any arbitrary way.

A substitute model 110 can be provided with any arbitrary number of RC-elements, i.e. two or more RC-elements. Preferentially, two or three RC-elements are used. Eventually, further components may be comprised in the substitute model, if they do not hamper the conduct of the described method for determination of the maximum allowable load current of an energy storage cell 100 or the method for determination of the maximum performance of an accumulator-unit 124.

A vehicle according to the disclosure may be any arbitrary vehicle. It may in particular be an automobile or a truck.

The substitute model 110 may preferentially be implemented as a simulation model in software. Alternatively, the substitute model may be implemented as an actual circuit, wherein the resistors and capacitors have adjustable resistances and capacitances.

Adapting process of the parameters of the substitute model 110 is preferentially performed in separate time intervals. Depending on the manifestation of the resistances and capacitances of the single RC-elements, the time intervals (Δta, Δtb, Δtc, . . . , Δtx) of the RC-elements may vary. In particular, they may abut to each other without temporal distance, thus directly to each other. A saturation state of a respective previous RC-element may be chosen in any arbitrary way. However, the above mentioned values of the 4-fold to the 7-fold of the respective time constant (τₓ₋₁) of the previous RC-element lend themselves as suitable values. However, alternatively other values may be chosen, like e.g. the 3.5-fold or the 9-fold or any arbitrary value in-between. The person skilled in the art will adjust the position and duration of the time intervals (Δta, Δtb, Δtc, . . . , Δtx) to the type of the energy storage cell, the structure of the runs of currents to be expected and in particular to the values of the emerging time constants.

The time constants assigned to an energy storage cell may preferentially be determined at the beginning of the lifetime by laboratory experiments, e.g. at. the manufacturer. Accordingly, also the other initial parameters of the substitute model may be defined according to values determined in laboratory experiments. Alternatively, a substitute model may be provided at the beginning of the lifetime of an energy storage cell with pre-defined lump-values as a parameter-set. Then, preferentially an initialization process of the energy storage cell and/or the accumulator-unit is performed. In such an initialization process, several adapting cycles may be passed, in order to achieve a high initial model quality of the substitute model. Thereby, several step currents with a succeeding constant current level each may be produced artificially at the energy storage cell or the accumulator-unit, respectively.

In the explanations and depictions mentioned above, it was assumed for simplification that a variation of the voltage due to a step current will originate from a constant initial value (V₀), wherein at the moment of the step current (t=0) an empty capacitor was assumed for all RC-elements. However, the mentioned methods can also be performed at any arbitrary different moment and any arbitrary different status of an energy storage cell or an accumulator-unit, respectively.

In the substitute model 110, at every point in time the charge states of the capacitors in the respective RC-elements can be calculated. Consequently, the illustrated calculations can be performed at any arbitrary run of voltage due to a step current with succeeding stable current level. Thereby, instead of the overall capacities (Ca, Cb, Cc, . . . , Cx) adjusted values can be utilized for the mentioned equations. In particular, the remaining residual capacitances resulting from the partly charged state of a capacitor can be used. In such a case, also a shift of the time-axis (t) can be performed by the amount of time, which would be required for reaching the actual partly charge of the respective capacitors at the measured run of current. Consequently, an adapting cycle can be performed at every arbitrary step current with a subsequent stable current level, thus also at a step current from a charging-state to a discharging-state or at an addition or removal of a considerable amount of current due to the activation of deactivation of an electric consumer. Under suitable adapting of the illustrated equations, also a current conversion (zero-crossing) at the step current is not defective.

What is claimed is:

1. A method for determination of a maximum allowable load current of an energy storage cell during its lifetime,
wherein a substitute model is used for simulation of the charging and discharging behavior of the energy storage cell, the substitute model containing a series connection of a series resistor with a resistance and at least two RC-elements, and
wherein a RC-element is constituted by a parallel connection of each a resistor with a resistance and each a capacitor with a capacitance, the method comprising the steps of:
adapting parameters of the substitute model during the lifetime of the energy storage cell, and
calculating the maximum allowable load current of the energy storage cell from the adapted parameters of the substitute model.

2. The method according to claim 1, characterized by the resistance of the series resistor and the resistances of the resistors and the capacitances of the capacitors in the RC-elements being adapted during the lifetime of the energy storage cell.

3. The method according to claim 1, characterized by the adapting process of parameters of the substitute model being performed by comparison of the measured run of the overall voltage at the energy storage cell, that emerges at the energy storage cell due to a measured run of current, with a calculated run of the overall voltage at the substitute model, that is calculated based on the same measured run of current at the energy storage cell,
wherein an adapting cycle is started, when the measured run of current has a sharp rise to a stable current level that lasts for a constant current interval, and
wherein the parameters of the substitute model are adapted such, that the calculated run of the overall voltage at the substitute model approximates the measured run at the energy storage cell.

4. The method according to claim 1, characterized by an adapting of the respective parameters for each RC-element being performed separately during individual time intervals.

5. The method according to claim 1, characterized by a difference between a measured run of voltage at the energy storage cell and a calculated run of voltage at the substitute model during a first time interval being used exclusively for the adapting process of the resistance and the capacitance of the first RC-element.

6. The method according to claim 1, characterized by a difference between a measured run of voltage at the energy storage cell and a calculated run of voltage at the substitute model during a second or further time interval being used exclusively for adapting process of a respective resistance and a respective capacitance of the second or further RC-element.

7. The method according to claim 1, characterized by an adapting process of the resistance and the capacitance of the first RC-element being performed, when the duration of the constant current interval is longer or equal to a first time constant for the charging and/or discharging behavior of the first RC-element.

8. The method according to claim 1, characterized by an adapting process of the resistance and the capacitance of the first RC-element being performed during a first time interval, the first time interval beginning at the occurrence of a step current with a succeeding stable current level.

9. The method according to claim 1, characterized by an adapting process of the respective resistance and the respective capacitance of the second or a further RC-element being performed, when the duration of the constant current interval is longer or equal to a respective time constant for the charging and/or discharging behavior of the second or a further RC-element.

10. The method according to claim 1, characterized by an adapting process of the respective resistance and the respective capacitance of the second or a further RC-element being performed during a respective second or further time interval, the second or further time interval beginning respectively not before a moment of saturation of the previous RC-element.

11. The method according to claim 1, characterized by an adapting process of the resistance of the series resistor being performed during each adapting cycle.

12. A method for determination of the performance of an accumulator-unit, the accumulator-unit having several energy storage cells, wherein a substitute model is used for simulation of the charging and/or discharging behavior of each energy storage cell, the method comprising the steps of:
calculating the maximum allowable load current of the accumulator-unit from the substitute model,
applying the maximum voltage for the maximum allowable load current to each energy storage cell is calculated from the substitute model, and
calculating the performance of the accumulator-unit from the maximum allowable load current of the accumulator-unit and the maximum voltages of the energy storage cells.

13. The method according to claim 12, characterized by the substitute model containing for each energy storage cell a series connection of a series resistor with a resistance and at least two RC-elements, and a RC-element being constituted by a parallel connection of each a resistor with a resistance and each a capacitor with a capacitance, and the respective parameters of the substitute model being adapted for each energy storage cell during the lifetime.

14. The method according to claim 12, characterized by the maximum allowable load current of the accumulator-unit being set to the value of a maximum allowable load current of the weakest energy storage cell.

15. The method according to claim 12, characterized by the weakest energy storage cell being determined as the cell, where a predetermined voltage threshold is reached with the lowest current.

16. The method according to claim 12, characterized by the maximum allowable load current at a weakest energy storage cell being determined by a method according to claim 1.

17. The method according to claim 12, characterized by the maximum performance of the accumulator-unit being calculated from a maximum allowable load current of the accumulator-unit and the maximum voltages being reached at the energy storage cells at appliance of this maximum allowable load current with the following formula:
$$P max = {\sum }_{i}^{n} ( V max , i ) * {I}^{*} max$$

18. The method according to claim 12, characterized by the performance being calculated separately for different permanent load intervals.

19. The method according to claim 12, characterized by the performance being calculated separately for a state with energy absorption and a state with energy output from the accumulator unit.

20. A control unit for determination of the performance of an accumulator-unit of a vehicle with two or more energy storage cells, wherein the control unit is configured to input the current at the accumulator-unit and a voltage at each energy storage cell from one or more detection means for detection, and the control unit being designed to perform a method according to claim 1.

21. The control unit according to claim 20, characterized by the control unit being designed to influence one or several electric consumers connected to the accumulator-unit in such a way, that a load current with a step current and a succeeding stable current level is produced.

22. The control unit according to claim 20, characterized by the control unit being designed to control a limitation device for limiting the load current of the accumulator-unit, such that the limitation device limits the load current of the accumulator in such a way that it stays smaller or equal to a maximum allowable load current of the weakest energy storage cell.
